(19) United States
(12) Patent Application Publication
(10) Pub. No.: US 2016/0095301 A1
(43) Pub. Date: Apr. 7, 2016

(54) CLOSED LOOP FISH AND PLANT FARMING STRUCTURE AND METHOD

(71) Applicant: Bruce Carman, Lutsen, MN (US)

(72) Inventor: Bruce Carman, Lutsen, MN (US)

(73) Assignee: MARINER FARMS, LLC, Lutsen, MN (US)

(21) Appl. No.: 14/873,489

(22) Filed: Oct. 2, 2015

Related U.S. Application Data
(60) Provisional application No. 62/059,564, filed on Oct. 3, 2014.

(51) Int. Cl. A01K 63/04; C02F 3/32; A01G 31/02

(52) U.S. Cl. CPC A01K 63/045; A01K 63/047; A01G 31/02; C02F 3/327; C02F 2307/00; C02F 2103/20

(57) ABSTRACT

A system, method and structure are presented to allow water from a fish tank to be pumped upward to an aquaponic trough on the top floor in a multi-floor greenhouse structure, from which the water will have a gravity-fed and unpumped flow to lower troughs. Furthermore, the application describes a plumbing system to control the feed of pumped and gravity fed water through the various aquaponic troughs and back to the fish tank at predetermined intervals.

### CROSS-REFERENCE TO RELATED APPLICATIONS

This application is a utility application claiming priority to U.S. provisional application No. 62/059,564, which was filed on Oct. 3, 2014 and is incorporated in its entirety herein by reference.

### FIELD OF THE INVENTION

The present application relates to a closed loop eco-system food product facility using aquaponic principles. More particularly, the described embodiments relate to the growing of fish in fish tanks while using fish waste to fertilize plants in a four leveled greenhouse structure wherein the levels of the greenhouse are exposed to a controlled flood and drain cycle of water exposure.

### SUMMARY

One embodiment of the present invention provides for a multi-level greenhouse structure with one or more growing troughs on each level. Water from one or more fish tanks is pumped to the trough(s) on the highest level of the greenhouse structure. The troughs are filled and emptied on a ¼-time fill, ¼-drain, ½-time sit empty schedule as determined by a computer-controlled system of valves. In one embodiment, each level or story has four, or a multiple of four, troughs. At any given time, one-fourth of the troughs are being filled, one-fourth are being emptied, and one-half are sitting empty with the plant roots exposed. This allows the water to be constantly pumped to the highest level. If the total cycle time is one hour, the water would be switched to a new upper-level trough every fifteen minutes.

The troughs on the lower levels are watered through the drainage of the troughs on the upper levels. If each trough drains to a trough directly below it, the lower trough would be one fifteen-minute cycle segment behind the trough above it. By making the greenhouse four stories, each trough would empty its water to the trough below it, with the bottom troughs emptying back into the fish tanks.

The greenhouse can be constructed with steel grating or other material which allows air and heat to rise up from the lower levels (or floors) to the upper levels. Plants grown on the upper levels can be selected from among those plants that grow best in warm, humid conditions. Curtain walls or other structures can be used to isolate troughs, with conditioned air being pumped into each trough compartment to create ideal growing conditions for the plants in each trough.

Water draining from an upper trough to a lower trough can pass through a hanging lattice of conduit in which plants are supported and grown. The lattice includes water pass-through pipes, with the hanging plants having roots that contact the water passing through the pass-through pipes. Water would then splash into the lower tank in a manner to increase the oxygen levels in the water.

### BRIEF DESCRIPTION OF THE DRAWINGS

Aspects and embodiments of the present invention are shown in the following figures:

FIG. 1 is a cross-sectional frontal view of a housing and a representative arrangement of growing troughs and their arrangement within the housing.

FIG. 2 is a cross-sectional side view of the housing and trough arrangement shown in FIG. 1.

FIG. 3 is an exterior front view of the housing shown in FIG. 1.

FIG. 4 is an exterior side view of the housing shown in FIGS. 1-3.

FIG. 5 is an exterior rear view of the housing shown in FIGS. 1-4.

FIG. 6 is an exterior side view of the opposite side of the housing shown in FIG. 4.

FIG. 7 is a more detailed interior view of the greenhouse portion of the housing shown in FIGS. 1-6.

FIG. 8 shows an embodiment of a plumbing or pipe assembly for controlling water flow to and through the troughs shown in FIG. 1.

FIGS. 9-13 are a sequence of illustrations depicting the flood and drain cycle of water to the troughs as provided by the pipe assembly of FIG. 8 and shown at 15 minute increments.

FIG. 14 is a detailed view of a growing trough and isolation system for creating a micro climate around a given trough within the greenhouse.

### DETAILED DESCRIPTION

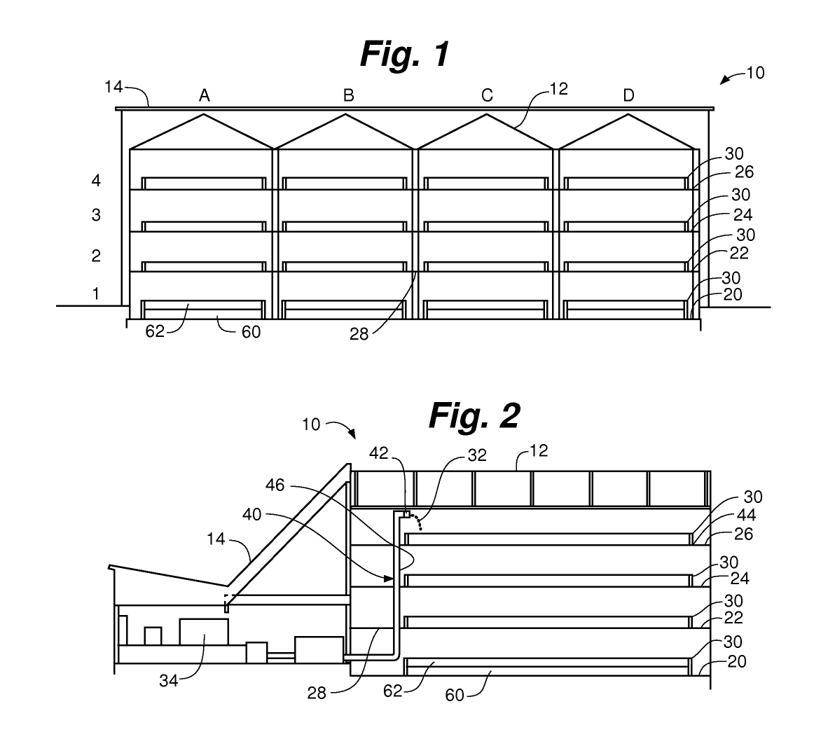

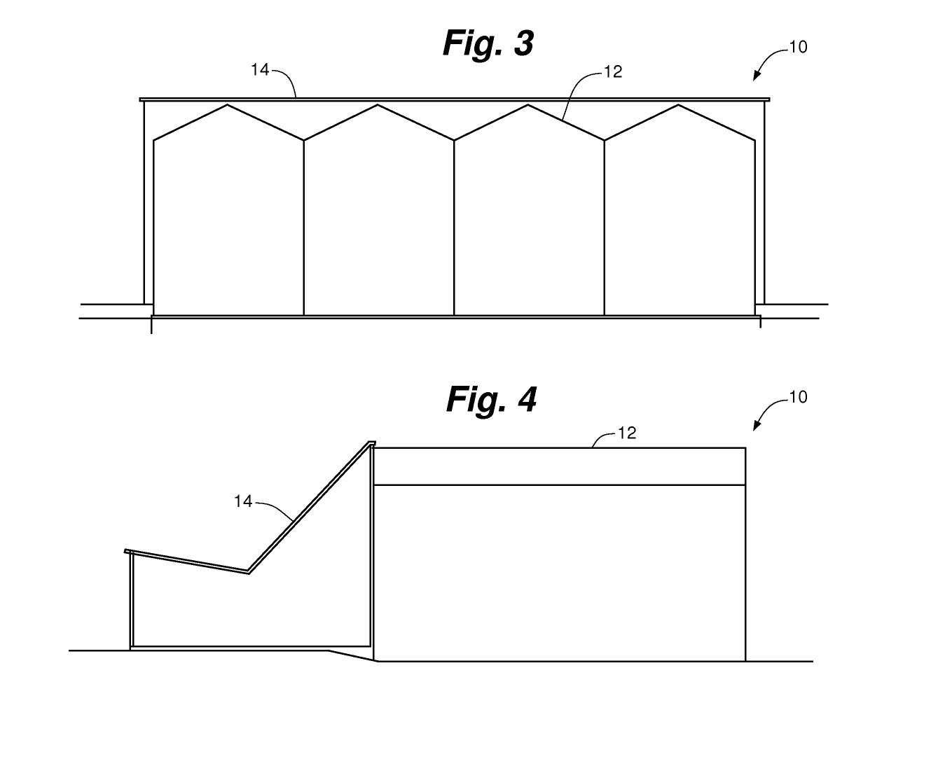

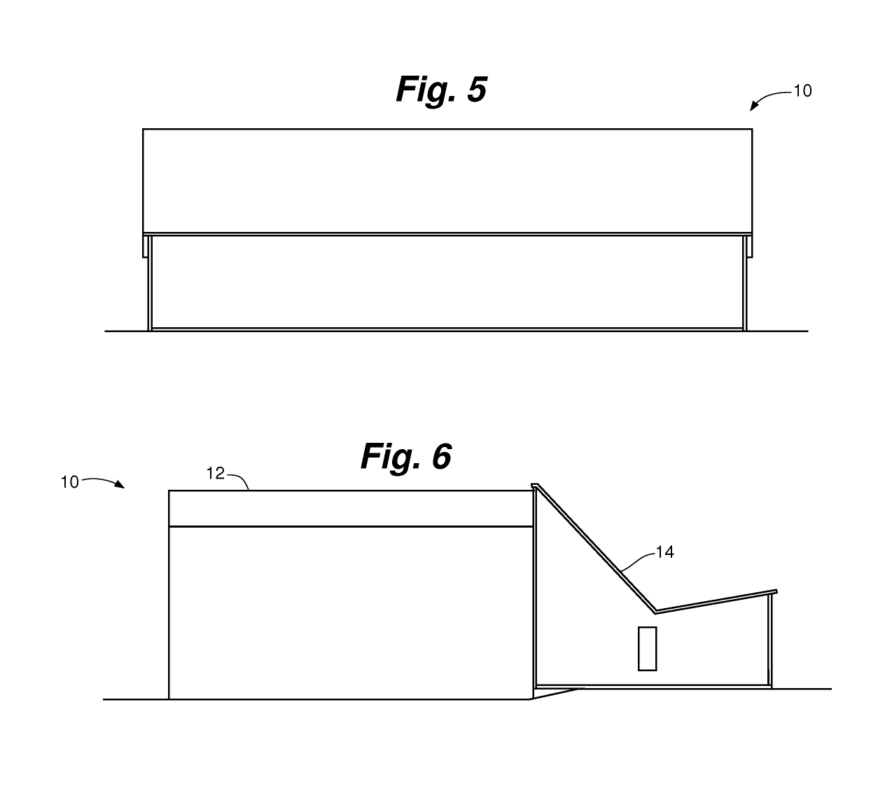

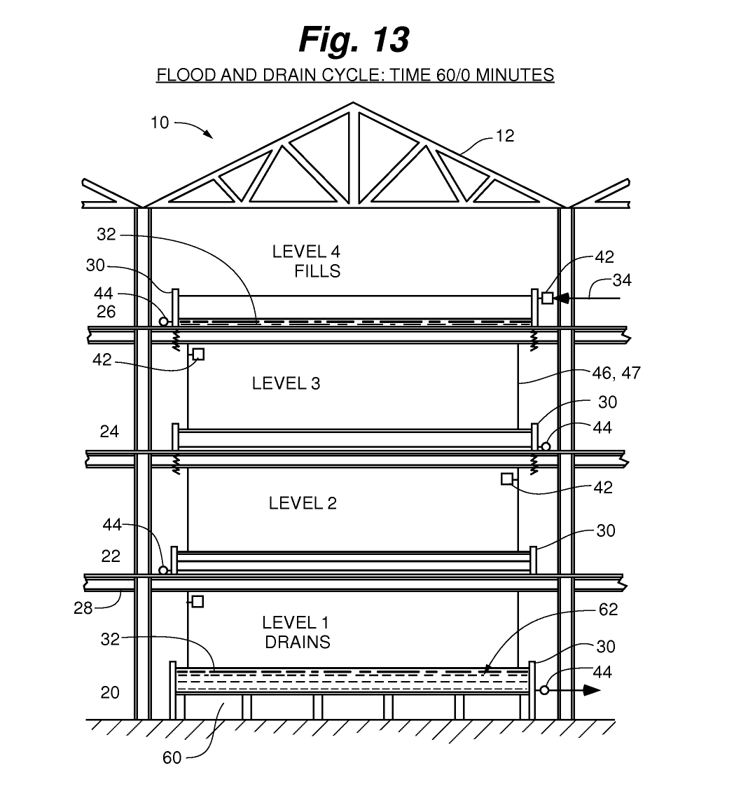

Inventive aspects of the aquaponics system and housing 10 shown in the various FIGS. 1-14 start with the structure of the greenhouse portion 12. Capable of vertical, multi-level design, the greenhouse portion 12 of the structure 10 can consist of many levels with its only limitations in overall height being the zoning regulations or the strength capacity of building materials. In the embodiment shown herein the greenhouse 12 consists of four levels: a ground or first level 20, a second level 22 directly above the first level 20, a third level 24 directly above the second level 22, and a top or fourth level 26 directly above the third level 24.

Typically, the structure 10 is a steel column and beam building divided into levels 20, 22, 24 and 26 through the use of steel grating or similar material, which has the strength necessary to support the aquaponic growing troughs 30 present on each level. The heights of each level 20, 22, 24 and 26 can vary or they can all be the same depending on the product to be cultivated on a specific level and the lighting requirements for that product. In at least one embodiment, steel grating is used in constructing the level partitions (floors/ceilings) 28 to allow air and heat to freely pass between levels and thus permit highly economical air flow throughout the facility. Other materials of sufficient strength and durability, and which also allow free transfer of air and heat therethrough may alternatively be used to construct the level partitions 28. The universal air flow, both horizontally and vertically, is very important to the growth of plants for pollination and by creating a consistent environment for humidity and temperature. The floor/ceiling material permits hot, humid air to rise naturally. This provides for individualized placement of specific plants species on a level-by-level basis defined by their requirements for humidity and temperature.

The ability to integrate multi-level design/construction also enables the facility to provide greater energy savings. By controlling heat loss vertically rather than horizontally like your typical greenhouse, the facility 10 provides economic and environmental benefits to the user.

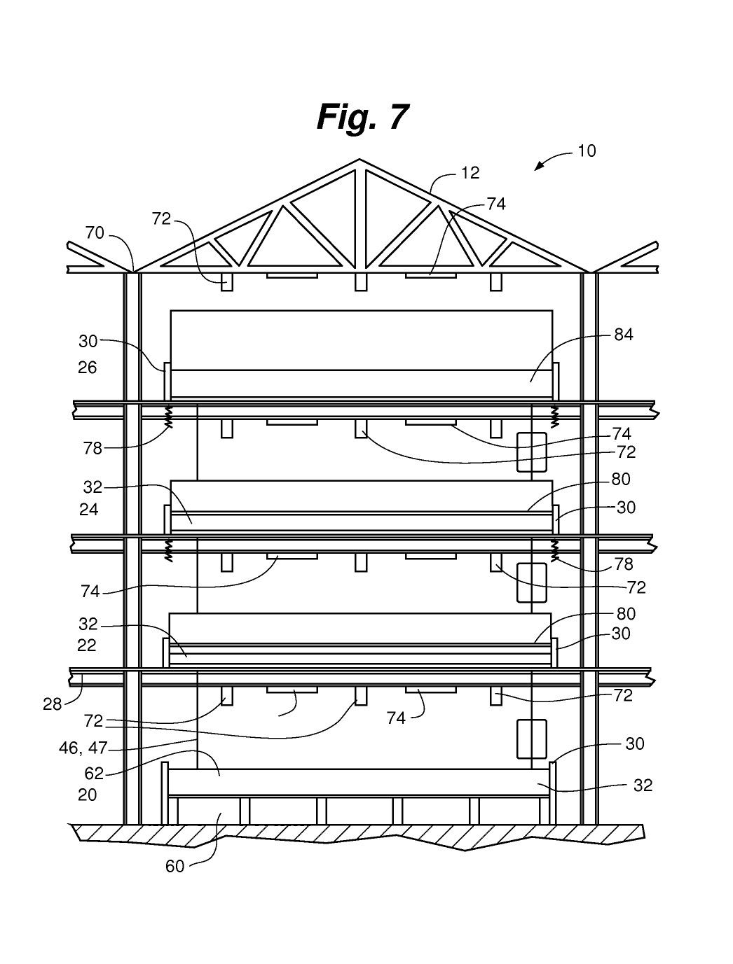

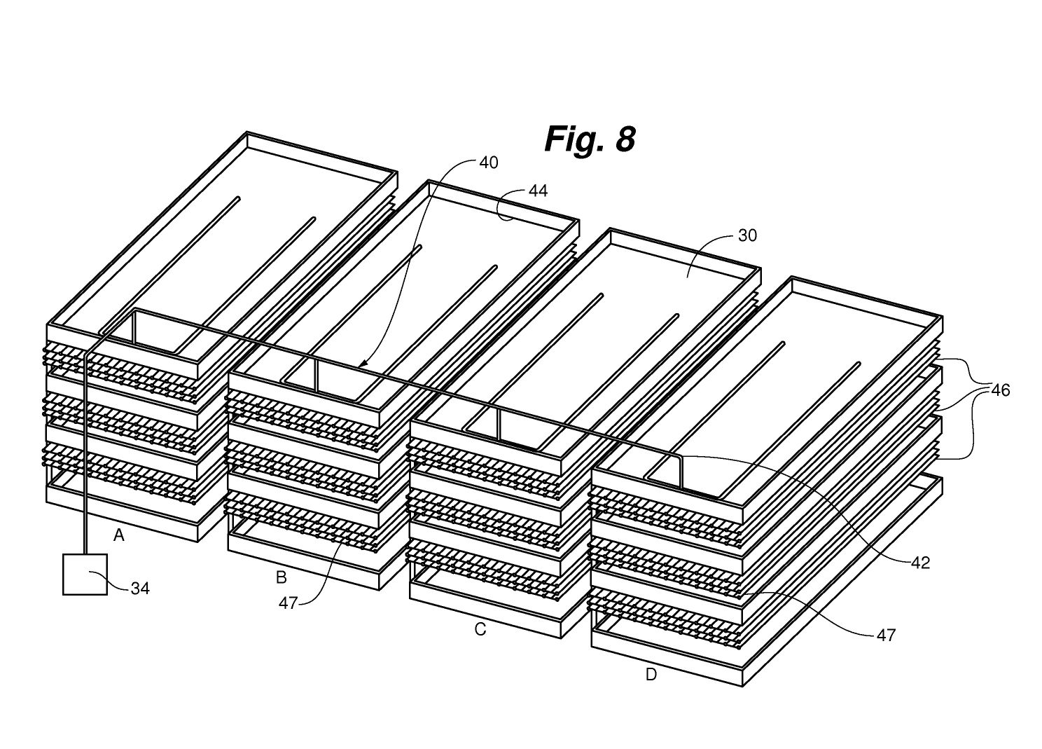

As is depicted in the various FIGS. 1-2 and 7-13 the multi-level design provides for the vertical stacking of the troughs 30 “one on top of another”. As is best shown in FIGS. 7 and 9-13, this provides for the flow of the nutrient rich water 32 from the trough(s) 30 on the top level 26 to the trough(s) 30 on the ground level 20 through the use of gravity, which reduces both capital and operating expenditures while enhancing product growth. A computerized control system (not shown) can be used to activate valves 42 (water entry valve 42) and 44 (drain valve 44) of a plumbing system 40 (see FIGS. 8-13) to open and close, thereby directing the gravitational flow of the nutrient water 32 through the levels 20, 22, 24, 26 and troughs 30 thereon. The system 10 shown ensures that the only pumping of water necessary is in the initial filling of the first trough 30 on the fourth level 26.

As depicted in FIG. 2, it can be seen that water flow through the troughs 30 begins with the vertical pumping of the nutrient water 32 from at least one fish tank 34 located in the fish growing portion 14 of the housing 10, via the conduit 46 and valves 42, 44 of the plumbing system 40. It should be noted, that while multiple valves 42 and 44 may be used, as in the manner shown, in at least one embodiment the use of only a single entrance valve 42 is necessary and each trough 30 is provided with a single drain 44. A detailed view of an example plumbing system 40, including lattice 47 (discussed in greater detail below) is shown in FIG. 8.

The fish growing portion 14 of the housing 10 can be constructed and arranged in a variety of ways. The structure of the fish growing portion 14 may be of any conventional construction materials, and may be immediately adjacent to the greenhouse portion 12 (as shown in the various figures) or separate therefrom. The fish growing portion 14 must however contain at least one fish tank 34 suitable for containing fish and a sufficient reservoir of water to fill the troughs 30 in the manner mentioned above and described in greater detail below. The at least one fish tank 34 must also be in communication with the plumbing system 40.

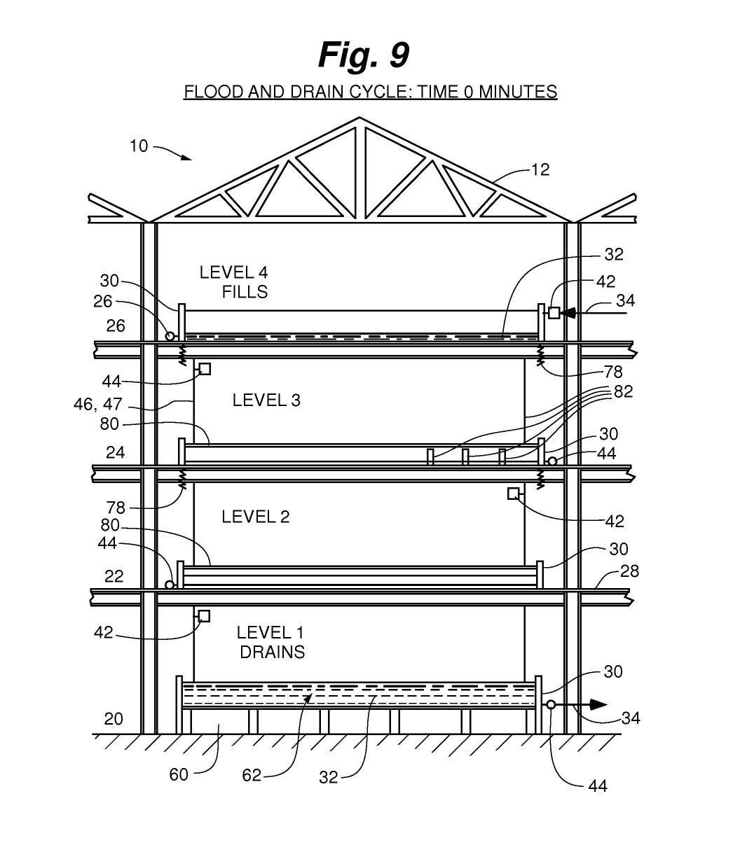

An example of the pumping and dispersion of nutrient water 32 into and through the troughs 30 is illustrated in FIGS. 9-13. As shown therein, nutrient water 32 is pumped from the fish tank(s) 34 of the fish growing area 14 (shown in FIG. 2 and represented in FIGS. 9-13 by arrow 34) to the trough or troughs 30 located on the fourth level 26 of the greenhouse 12.

As depicted in FIG. 8 the plumbing system 40 brings the nutrient water 32 a vertical distance of approximately 25-30 feet (from the bottom of the at least one fish tank 34 to the truss bearing height of the greenhouse's fourth level 26) where the nutrient water 32 can be distributed horizontally through the trough or troughs 30 located on the fourth level 26. From there the water 32 will free fall vertically into each trough 30, though a branch pipe or conduit 46, of the progressively lower levels 24, 22, and 20. By selectively opening and closing the valves 42,44 troughs 30 on each level 26, 24, 22, 20 are flooded or filed for 15 minutes and then subsequently allowed to drain for 45 minutes; at which point the cycle is repeated as shown in FIGS. 9-13.

After the flooding of the trough(s) 30 on the fourth level 26 for the desired 15 minute period, the nutrient water 32 will drain from the fourth level trough at a location diagonally located from the entry point. This will ensure even flow and distribution of the nutrients within the trough volume. The water will essentially free fall, contained in a pipe from the fourth level 26 trough 30 to the third level 24 trough 30 located directly under it. Again the flooding of the troughs will occur for a period of 15 minutes and then will be subsequently drained for a period of 45 minutes.

The process is repeated in order to transfer the nutrient water from the third level 24 trough 30 to the second level 22 trough 30 located directly under it, including the diagonal flow of nutrient water across the trough, from entry point to draining point. The second level 22 trough 30 will also fill for 15 minutes and then drain for 45 minutes.

The filling of the first level (ground floor) 20 trough 30 happens in the same manner as the troughs 30 on the second 22 and third level 24 with the free fall, in a pipe or conduit 46, of nutrient water 32 into it from the trough above. Nutrient water in the first level 20 trough 30 is oxygenated and then pumped into the fish tank 34.

As best shown in FIG. 8 but also depicted in FIGS. 9-13 an alternative or in addition to containing the flow of water in conduit 46 for “free fall” between the troughs 30 of each level, the plumbing system 40 may also include conduit lattice 47 above one or more troughs 30 to provide additional surface area for hanging plants to grow (see FIG. 7 for illustration of hanging plant). The lattice 47 may have a plurality of openings into which the plant is secured directly. This allows the plant's roots to be exposed directly to the water flowing through the lattice 47, thereby allowing the plant to gain nutrients from the flowing water and further oxygenating it. In effect using the plumbing system 40 as a mechanism to increase the productivity of the system 10.

Though the system 10 of the present disclosure is idealized using the aforementioned flood and drain water cycle of 1 hour duration, in a greenhouse portion 12 having four levels 20, 22, 24, 26, the number of troughs 30 on each level is limited only by the size of the faculty build to contain them. For example, in the embodiment shown in FIGS. 1 and 8 a system 10 having four similarly sized troughs 30 on each level 20, 22, 24, 26 of the greenhouse portion 14 is shown. Thus forming a grid of sixteen troughs in four horizontal rows (each level) and four vertical columns.

For ease of discussion each column of troughs 30 is labeled alphabetically A, B, C and D, and numbered according to their corresponding level of 1, 2, 3 and 4. In such an arrangement, the plumbing system 40, is utilized via manipulation of valves 42 and 44 to start the water circulation cycle depicted in FIGS. 9-13 at 15 minute intervals for each column.

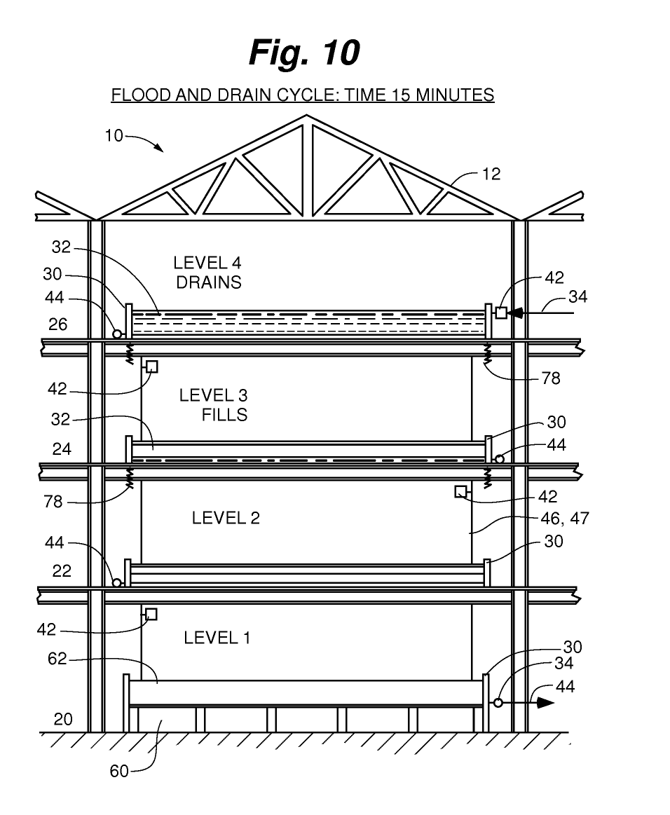

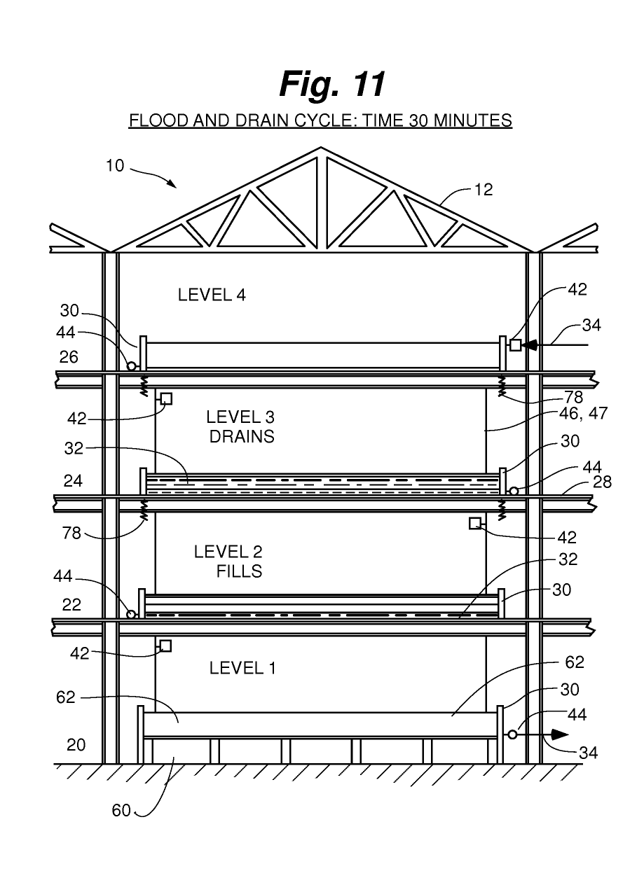

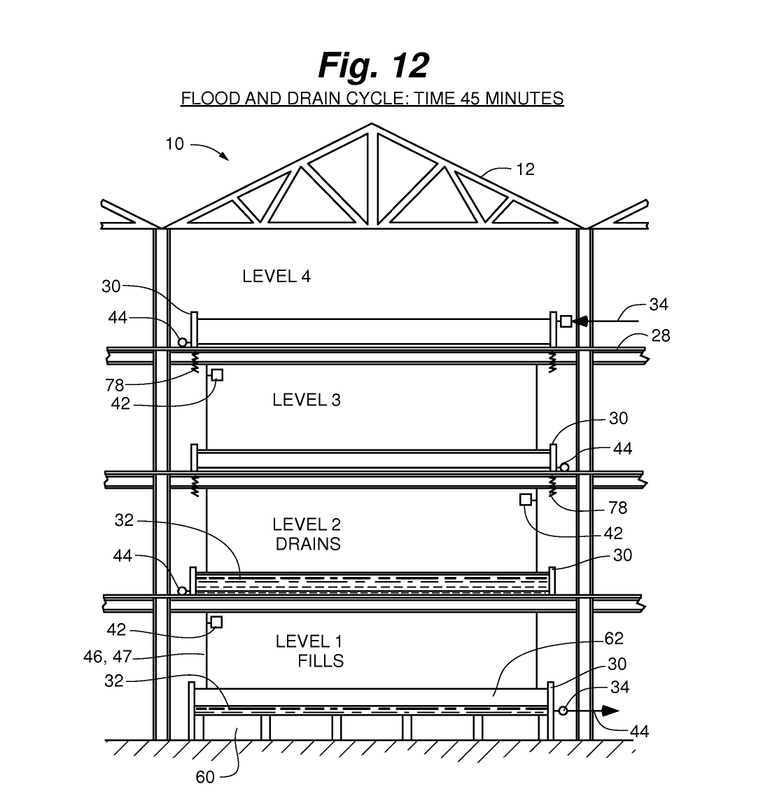

For example: when the troughs 30 of column A are at time zero of the water cycle (shown in FIG. 9) the adjacent troughs of column B are 15 minutes ahead in the cycle (as shown in FIG. 10), and the adjacent troughs 30 of column C are at time 30 minutes (as shown in FIG. 11), and the adjacent troughs 30 of column D are at time 45 minutes (as shown in FIG. 12). This pattern of off set timing may be varied or altered by columns in any manner desired by manipulation of valves 42 and 44 in adjacent columns. In addition, it should be noted that in a similar manner the plumbing system 40 is capable of bypassing water flow to individual troughs 30 or the entire column of troughs so as to allow for cleaning, maintenance, harvesting of plants or for any reason.

The troughs 30 present on each level 20, 22, 24, 26 may be of similar or different construction and/or arrangement. Troughs may be of different dimensions but to better control and regulate water flow, ideally they should be similar. In at least one embodiment all of the troughs 30 have an interior dimension of approximately 20 feet×48 feet×2 feet.

In the embodiment shown and described herein, though the troughs 30 are all of similar dimension they do have some distinctions. For example, in the embodiment shown in FIG. 7 the trough 30 of the first level 20 is contains two distinct reservoirs 60 and 62 for containing two distinct forms of water. Reservoir 60 is a reservoir for collecting and containing rain water run off that is diverted from the guttering 70 of the housing 10 and/or from other storm water collection sources. Reservoir 62 is positioned above the rain water reservoir 60 and contains nutrient water 32 to a level of approximately 18 inches during the “flood” part of the first level water cycle (see discussion above). During the “drain” portion of the cycle, the level of nutrient water 32 contained in the reservoir 62 may drop up to 12 inches. In the embodiment shown, reservoir 62 is used to raise algae and duckweed to aid in cleaning and oxygenating the water before it is returned to the fish tank(s) 30; as such reservoir 62 is never allowed to become fully dry.

The rain water reservoir 60 is separate from the nutrient water reservoir 62, but the water contained therein may be accessed via the plumbing system 40. Water from reservoir 60 may be added to the nutrient water 32 when necessary in order to compensate for water lost from evaporation, splashing, spills, etc.

The troughs 30 shown on the second level 22 and third level 24 include a floating mat 80 of porous material such as rigid insulation, etc. The mat 80 acts as a substrate upon which crops such as lettuce and microgreens may be grown. The root structure of the crops passes through the mat 80 and into the nutrient water reservoir 62 below.

The depth of reservoir 62 in the troughs 30 of level two and three 22, 24 is between about 6 and 14 inches. In embodiments where the depth of the reservoir 62 is less than 12 inches the reservoir 62 may be completely drained of nutrient water 32 during the “drain” phase of the watering cycle.

As mentioned, the second level 22 and third level 24 troughs 30 will use the floating raft method of aquaponic growth and will employ a flood and drain cycle that may drain approximately half (or more) the water volume contained in each trough 30. In such embodiments each trough 30 can contain a level of 12 inches of nutrient water 32 at the completion of the flood period. Whereas at the completion of the draining period, the nutrient water level will be 6 inches. That 6 inch level will be maintained during the two—15 minute breathing periods (between flood and drain) as well. Draining half the nutrient water enables the roots of the lettuce plants to become exposed to oxygen which will enhance and promote plant growth.

A reason for maintaining the 6 inches of nutrient water in the reservoir 62 is to permit any nutrient sediment to settle out of the nutrient water to a false bottom 82 of the trough 30 (see FIG. 9). The false bottom 82 will be placed 1″ to 2″ inches above the actual bottom of the trough to facilitate trough drainage. The false bottom 82 is placed in the trough 30 to capture and hold the nutrient sediment. This provides for more refined breakdown of the sediment.

Returning now to the illustrative example of the system 10 shown in FIG. 7 and back up the to the trough(s) 30 of the fourth level 26, each trough 30 will contain a growing media 84 that may include expanded clay pellets, such as for example hydroton expanded clay media. The depth of the media may be approximately 16 inches.

Due to the natural tendency for heat to rise, the fourth level environment is going to be very warm, 80 degrees and warmer, and very humid, 60% and greater, almost a tropical environment. The primary plants to be grown on the fourth floor will be: Tomatoes, Basil, Green Peppers, and/or other crops where a warm and wet environment is desirable for their growth.

As already mentioned, the fourth level 26 troughs 30 will be the first of the troughs 30 to receive the nutrient rich water 32. Additionally, they will also receive a greater amount of un-dissolved solids from fish waste or leftover food. The use of inert growing media 84 to capture and in essence “provide a home” for this un-dissolved nutrient matter is a key component of the water flow system. The un-dissolved matter settles within the expanded clay pellets, advancing further nutrient breakdown and dissolving. The growing media also provides an undisturbed structure for the root system of plants that require such structure for long term growth and production. The plants roots will also be able to seek out and collect the nutrients that have collected on the clay pellets which also help break down the solids.

To aid in the breakdown of the un-dissolved solids, earthworms may also be placed in the growing media 84. The worms will eat and digest the solids, leaving behind their waste castings which are an excellent form of nutrient for the plants. The worms will also construct passage ways within the clay pellet media 84 that will promote nutrient water 32 flow during the time the trough 30 is flooded. When the trough is drained, these passage ways will permit oxygen to flow through the media which will enhance plant growth and nutrient breakdown. Further breakdown of the nutrients permits the nutrients to become dissolvable and easier for the plants consume. The worms can then be harvested from time to time to be fed to the fish, reducing the expense of organic fish food and thereby reducing the cost of all the products produced in the facility.

After passing through the fourth level 26 through second level 2,2 as described above the nutrient water 32 drains to the first floor 20 troughs 30 which are used primarily to grow algae and duck weed.

Obviously it is not always appropriately sunny, nor can sufficient environmental conditions for plant growth be guaranteed in any greenhouse year round. As such, the present system 10 employs lighting and atmospheric (HVAC) systems to ensure and enhance growing conditions as necessary.

For example, as depicted in FIG. 7 each level 20, 22, 24, 26 includes lighting fixtures 72 affixed to and/or suspended from the level partition 28. There may be any number or type of lighting fixture provided to a given trough 30. Lighting may be customized to provide specific spectrums and/or intensity. In at least one embodiment the fixtures are LED lights which require minimal power to provide sufficient growing illumination and thus increase the overall efficiency of the system 10.

Air flow, temperature and humidity may similarly be enhance or controlled by the use of inflow and outflow vents 74 that may be used to regulate and control air flow within an entire level or around a specific trough 30.

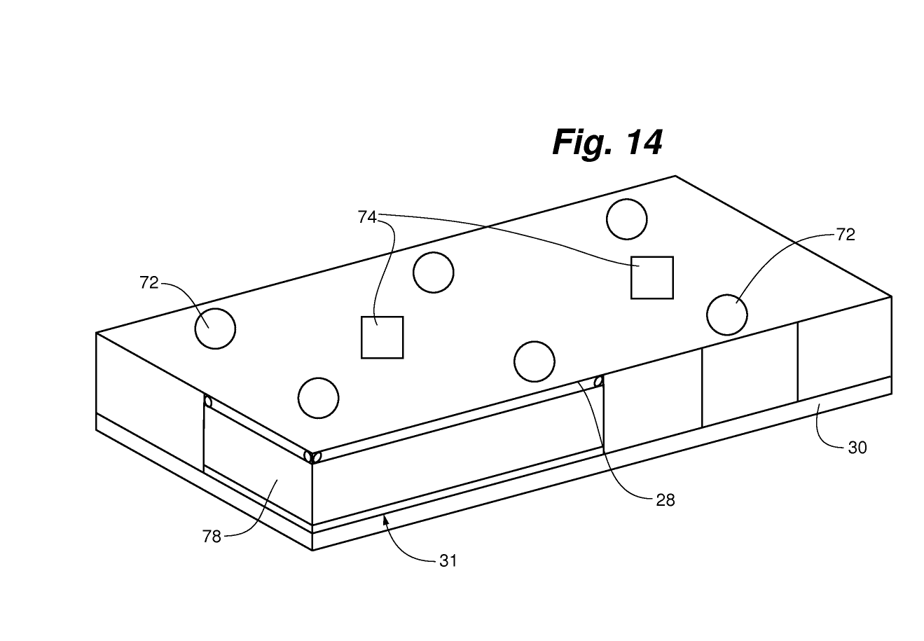

In some embodiments of the present system 10, a still greater degree of environmental control of a specific trough's growing conditions can be provided through the use of isolating curtains 78 which may be drawn around a trough 30 such as in the manner shown in FIG. 14. Trough 30 may be partially or fully enclosed by a curtain 78, whereupon all aspects of the trough's growing conditions may be customized via manipulation of the valves 42, 44 (not shown in FIG. 14) vents 74 and lighting fixtures 72.

Curtain 78 may be suspended from level partitions 28 (see also FIGS. 7 and 9-13). To properly secure a trough 30 from the surrounding environment, the curtain 78 may be secured or sealed to the ledge 31 of the trough to minimize temperature and humidity variations. Various mechanisms such as hook and loop type fasteners (VELCRO®), buttons, hooks, zippers, etc. can be used to secure the curtain 78 and trough ledge 71.

The curtains 78 themselves may be of any construction desired. In some embodiments that are flexible plastic sheeting. In some embodiments they may include a plurality of rigid plastic, fiberglass or even glass panels. In at least one embodiment the curtains 78 include a reflective surface or coating on the interior of the curtain 78 so as to reflect lighting from fixtures 72 back onto the growing area of the trough 30.

The many features and advantages of the invention are apparent from the above description. Numerous modifications and variations will readily occur to those skilled in the art. Since such modifications are possible, the invention is not to be limited to the exact construction and operation illustrated and described. Rather, the present invention should be limited only by the following claims.

What is claimed is:

1. An aquaponics system comprising:
a housing, the housing including a fish growing area and a green house,
the fish growing area having at least one fish tank, the at least one fish tank configured to contain fish and nutrient water;
the greenhouse consisting of four levels:
a first level, a second level above the first level, a third level above the second level, and a fourth level above the third level;
the second level, the third level and the fourth level each having a floor through which air can readily pass between levels,
each level having at least one growing trough, on the second level, third level and fourth level the growing troughs having a substrate for growing plants contained therein and a nutrient water retaining region underlying the substrate,
on the first level the at least one growing trough comprises a nutrient water retaining reservoir;
the at least one fish tank and all of the troughs are in fluid communication via a plumbing system, the plumbing system includes conduit for transporting the nutrient water to and from the troughs and the at least one fish tank, the plumbing system configured to pass the nutrient water through the system in the following intervals:
i) from the at least one fish tank to the at least one growing trough on the fourth level,
ii) from the at least one growing trough on the fourth level to the at least one growing trough on the third level,
iii) from the at least one growing trough on the third level to the at least one growing trough on the second level,
iv) from the at least one growing trough on the second level to the at least one growing trough on the first level,
v) then from the at least one growing trough on the first level back to the at least one fish tank, the intervals occurring in a repeating cycle.

2. The system of claim 1 wherein the at least one trough on the first level comprises a rain water reservoir, the rain water reservoir being separate and from the nutrient water reservoir, the rain water reservoir being accessible by the plumbing system.

3. The system of claim 1 wherein the substrate contained in the at least one trough on the second level and the at least one trough on the third level comprising a mat of porous material.

4. The system of claim 3 therein the mat is configured to float in the nutrient water.

5. The system of claim 1 wherein the substrate contained within the at least one trough on the fourth level comprises an inert growing media.

6. The system of claim 5 wherein the inert growing media comprises expanded clay.

7. The system of claim 5 wherein the inert growing media has a depth of about 16 inches within the at least one trough.

8. The system of claim 1 wherein the conduit of the plumbing system is configured into a lattice, the lattice being positioned above at least one of the the at least one trough on the third level, the at least one trough on the second level, and the at least one trough on the first level.

9. The system of claim 1 further comprising at least one containment curtain, the at least one containment curtain being positioned adjacent to at least one trough, the at least one containment curtain having an open position and a closed position, in the closed position the at least one containment curtain at least partially surrounding the at least one trough and separating it from adjacent environmental conditions.

10. The system of claim 1 wherein the floor comprises steel grating.

11. The system of claim 1 wherein each interval is spaced by 15 minutes.

12. An aquaponics facility comprising:
a housing, the housing including a fish growing area and a green house,
the fish growing area having at least one fish tank;
the greenhouse consisting of four levels:
a first level, a second level above the first level, a third level above the second level, and a fourth level above the third level;
the second level, the third level and the fourth level each having a floor through which air can readily pass between levels,
each level having at least one growing trough,
the at least one fish tank and all of the troughs are in fluid communication via a plumbing system, the plumbing system includes conduit and valves configured to transport nutrient water from the at least one fish tank to the at least one trough on the fourth level, the nutrient water flowing from the at least one trough on the fourth level floor though the plumbing system to the at least one trough on other levels by gravity.

13. A four story food production facility comprising:
a) a base floor;
b) three upper stories above the base floor, the upper stories each having a floor with steel grating to allow warm air to rise from the lower floor to the upper floor;
c) an aquaponic trough on the base floor and each upper story;
d) a fish tank containing fish;
e) pumping equipment to pump the water from the fish tank to the upper-most aquaponic trough;
f) water plumbing connecting:
i) the fish tank to the upper-most aquaponic trough to allow the pumped flow of water from the fish tank,
ii) each aquaponic trough on an upper story to an aquaponic trough below it to allow the gravity-fed flow of water to the lower trough, and
iii) the aquaponic trough on the base floor to the fish tank;
g) valves controlling the flow of water through the water plumbing;
h) a computerized system controlling:
i) the pumping of water from the fish tank to the upper-most aquaponic trough, and
ii) the valves to allow water to flow through the water plumbing.
